(19) United States
(12) Patent Application Publication
(10) Pub. No.: US 2009/0198723 A1
(43) Pub. Date: Aug. 6, 2009

(54) SYSTEM AND METHOD FOR WEB-BASED DATA MINING OF DOCUMENT PROCESSING INFORMATION

(76) Inventors: Andrey I. Savov, Fullerton, CA (US); Ajit Sodhi, Irvine, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/026,178

(22) Filed: Feb. 5, 2008

(51) Int. Cl. G06F 17/30

(52) U.S. Cl. 707/102; 707/E17.044

(57) ABSTRACT

The subject application is directed to a system and method for web-based data mining of document processing device information. User identification data corresponding to an identity of multiple users is first received at each of a plurality of document processing devices. Device status data is then received corresponding to document processing operations at each of the devices, with a portion of status data associated with user identification data. Structured machine data, including user identification data and device data in machine reasoning format, is then output from each document processing device to a data network. Structured machine data is then received from each of the document processing devices via the associated network. A database is then generated from received machine data, and query data is received relative to operation of the document processing devices. A report is generated based upon response data extracted from the database according to the query data.

### BACKGROUND OF THE INVENTION

The subject application is directed generally to accumulation and reporting of device status associated with document processing devices. The application is particularly applicable to web-based data mining using data in a web ontology language format.

Document processing devices in widespread use today include copiers, printers, facsimile machines, and scanners. More frequently, two or more of the functions associated with these devices are combined into one device, referred to as a multifunction peripheral or MFP. Given the cost of obtaining and maintaining complex document processing devices, they are often shared among many users which communicate with them over a data network.

Acquisition and maintenance of document processing devices is sufficiently involved such that many enterprises will relegate the task to system administrators. Administrator tasks include monitoring machine usage, monitoring statu of consumables, and monitoring user habits or preferences. Accurate information on machine status or usage allows administrators to strategically acquire new devices, shift locations of devices, adjust machine default parameters, add or delete features, or the like.

### SUMMARY OF THE INVENTION

In accordance with one embodiment of the subject application, there is provided a system and method for accumulation and reporting of device status associated with document processing devices.

Further, in accordance with one embodiment of the subject application, there is provided a system and method for web-based data mining using data in a web ontology language format.

Still further, in accordance with one embodiment of the subject application, there is provided a system for web-based data mining of document processing information. The system comprises a plurality of document processing devices. Each document processing device includes means adapted for receiving user identification data corresponding to an identity of a plurality of users, means adapted for receiving device status data corresponding to a plurality of document processing operations, wherein at least a portion of the device status data is associated with user identification data, and means adapted for outputting, to an associated data network, structured machine data inclusive of received user identification data and received device data in machine reasoning data format. The system also includes means adapted for receiving structured machine data from each of the plurality of document processing devices via the associated network and database generation means adapted for generating a database in accordance with received machine data. The system further includes means adapted for receiving query data corresponding to a query relative to operation of the plurality of document processing devices, extraction means adapted for extracting response data from the database in accordance with received query data, and means adapted for generating a report in accordance with extracted response data.

In one embodiment of the subject application, the structured machine data is comprised of data structured in web ontology language format.

In another embodiment of the subject application, the extraction means is comprised of a machine reasoning system.

In a further embodiment of the subject application, the database generation means generates the database inclusive of at least one of a resource definition framework, resource definition framework schema, and OWL web ontology language.

In yet another embodiment of the subject application, the system also comprises an indexing means adapted for generating indexing data in accordance with content of the database.

In another embodiment of the subject application, the extraction means includes means adapted for automatically extracting response data from the database upon updating thereof with newly received machine data.

Still further, in accordance with one embodiment of the subject application, there is provided a method for web-based data mining of document processing information in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for web-based data mining of document processing device information according to one embodiment of the subject application;

FIG. 2 is a block diagram illustrating device hardware for use in the system for web-based data mining of document processing device information according to one embodiment of the subject application;

FIG. 3 is a functional diagram illustrating the device for use in the system for web-based data mining of document processing device information according to one embodiment of the subject application;

FIG. 4 is a block diagram illustrating controller hardware for use in the system for web-based data mining of document processing device information according to one embodiment of the subject application;

FIG. 5 is a functional diagram illustrating the controller for use in the system for web-based data mining of document processing device information according to one embodiment of the subject application;

FIG. 6 is a diagram illustrating a server for use in the system for web-based data mining of document processing device information according to one embodiment of the subject application;

FIG. 7 is a diagram illustrating a workstation for use in the system for web-based data mining of document processing device information according to one embodiment of the subject application;

FIG. 8 is a flowchart illustrating a method for web-based data mining of document processing device information according to one embodiment of the subject application; and

FIG. 9 is a flowchart illustrating a method for web-based data mining of document processing device information according to one embodiment of the subject application.

### DETAILED DESCRIPTION OF THE PREFERRED EMBODIMENT

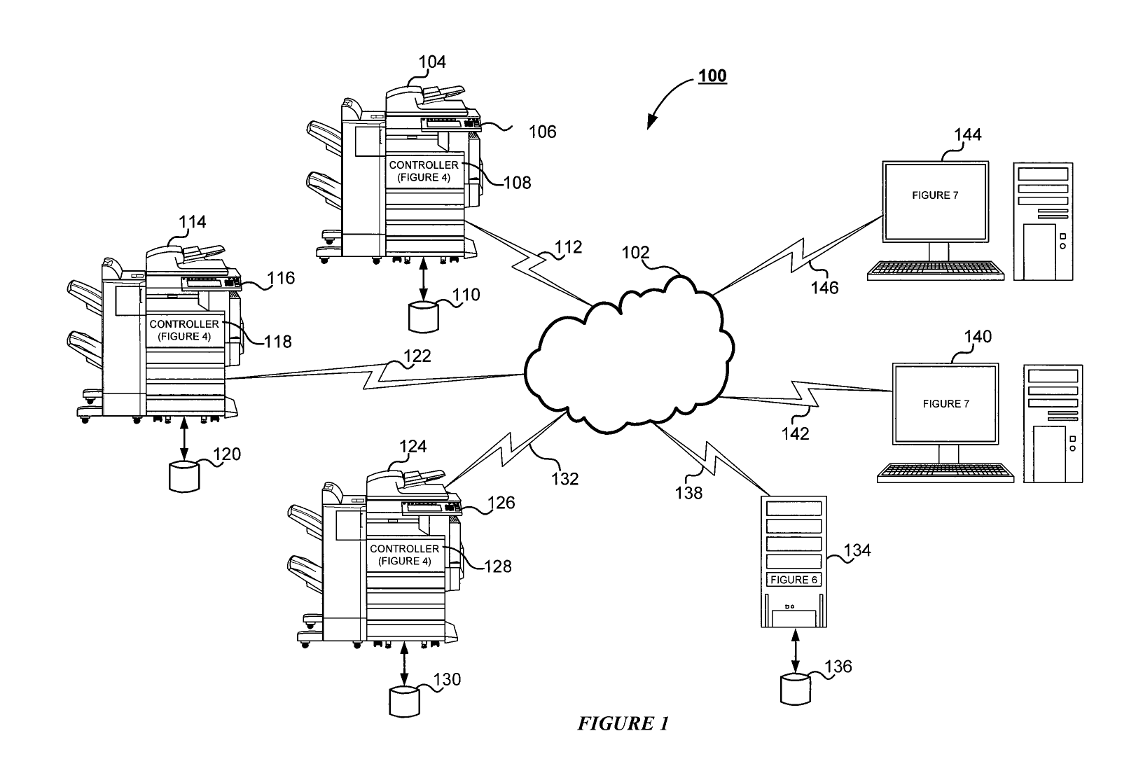

The subject application is directed to a system and method for accumulation and reporting of device status associated with document processing devices. In particular, the subject application is directed to a system and method for web-based data mining using data in a web ontology language format. More particularly, the subject application is directed to a system and method for web-based data mining of document processing information. It will become apparent to those skilled in the art that the system and method described herein are suitably adapted to a plurality of varying electronic fields employing device monitoring, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for web-based data mining of document processing device information in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a plurality of document processing devices 104, 114, and 124, depicted in FIG. 1 as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104, 114, and 124 are suitably adapted to provide remote document processing services to external or network devices. Preferably, the document processing devices 104, 114, and 124 include hardware, software, and any suitable combination thereof, configured to interact with an associated user, a networked device, or the like.

According to one embodiment of the subject application, the document processing devices 104, 114, and 124 are suitably equipped to receive a plurality of portable storage media, including, without limitation, Firewire drive, USB drive, SD, MMC, XD, Compact Flash, Memory Stick, and the like. In the preferred embodiment of the subject application, the document processing devices 104, 114, and 124 further include associated user interfaces 106, 116, and 126, respectively, such as a touch-screen, LCD display, touch-panel, alpha-numeric keypad, or the like, via which an associated user is able to interact directly with the document processing devices 104, 114, and 124. In accordance with the preferred embodiment of the subject application, the user interfaces 106, 116, and 126 are advantageously used to communicate information to the associated user and receive selections from an associated user. The skilled artisan will appreciate that the user interfaces 106, 116, and 126 comprise various components, suitably adapted to present data to the associated user, as are known in the art. In accordance with one embodiment of the subject application, the user interfaces 106, 116, and 126 comprise a display, suitably adapted to display one or more graphical elements, text data, images, or the like, to an associated user, receive input from the associated user, and communicate the same to a backend component, such as controllers 108, 118, and 128, respectively, as explained in greater detail below. Preferably, the document processing devices 104, 114, and 124 are communicatively coupled to the computer network 102 via suitable communications links 112, 122, and 132, respectively. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

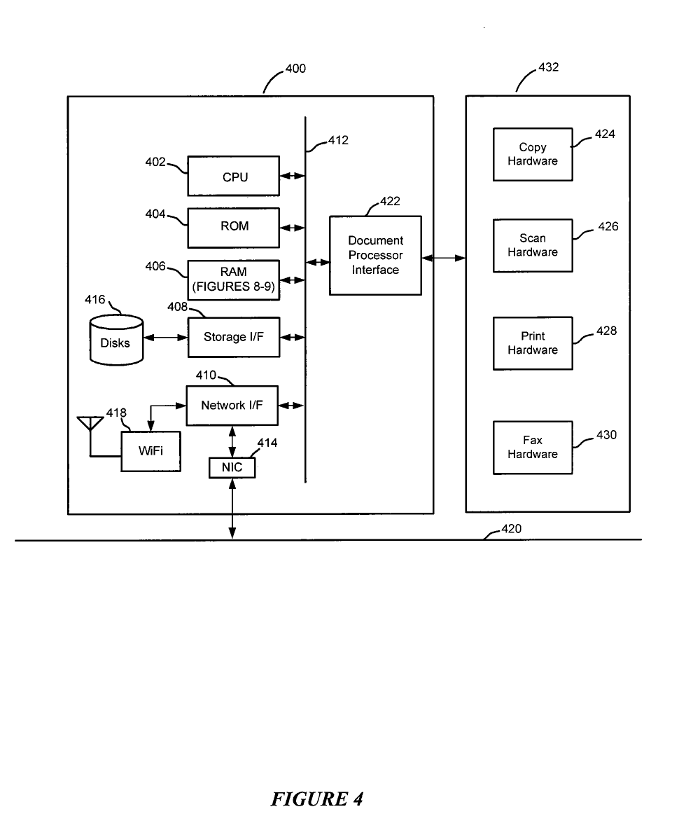

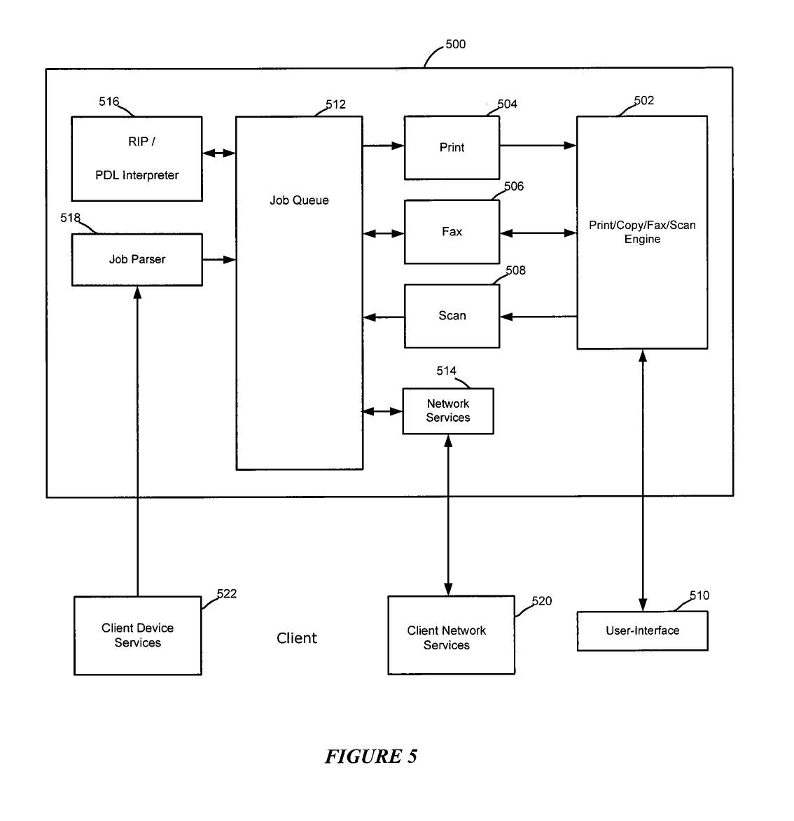

In accordance with one embodiment of the subject application, the document processing devices 104, 114, and 124 further incorporate backend components, designated, respectively, as the controllers 108, 118, and 128, suitably adapted to facilitate the operations of the document processing devices 104, 114, and 124, as will be understood by those skilled in the art. Preferably, the controllers 108, 118, and 128 are embodied as hardware, software, or any suitable combination thereof, configured to control the operations of the associated document processing devices 104, 114, 124, facilitate the display of images via the respective user interfaces 106, 116, and 126, direct the manipulation of electronic image data, and the like. For purposes of explanation, the controllers 108, 118, and 128 are used to refer to any myriad of components associated with the document processing devices 104, 114, and 124, including hardware, software, or combinations thereof, functioning to perform, cause to be performed, control, or otherwise direct the methodologies described hereinafter. It will be understood by those skilled in the art that the methodologies described with respect to the controllers 108, 118, and 128 are capable of being performed by any general purpose computing system, known in the art, and thus the controllers 108, 118, and 128 are representative of such general computing devices and are intended as such when used hereinafter. Furthermore, the use of the controllers 108, 118, and 128 hereinafter is for the example embodiment only, and other embodiments, which will be apparent to one skilled in the art, are capable of employing the system and method for web-based data mining of document processing device information of the subject application. The functioning of the controllers 108, 118, and 128 will better be understood in conjunction with the block diagrams illustrated in FIGS. 4 and 5, explained in greater detail below.

Communicatively coupled to the document processing devices 104, 114, and 124 are data storage devices 110, 120, and 130, respectively. In accordance with the preferred embodiment of the subject application, the data storage devices 110, 120, and 130 are any mass storage devices known in the art including, for example and without limitation, magnetic storage drives, hard disk drives, optical storage devices, flash memory devices, or any suitable combination thereof. In the preferred embodiment, the data storage devices 110, 120, and 130 are suitably adapted to store document data, image data, electronic database data, device status data, user identification data, user historical usage data, or the like. It will be appreciated by those skilled in the art that while illustrated in FIG. 1 as being separate components of the system 100, the data storage devices 110, 120, and 130 are capable of being implemented as internal storage components of the respective document processing devices 104, 114, 124, a component of the respective controllers 108, 118, 128, or the like, such as, for example and without limitation, internal hard disk drives, or the like.

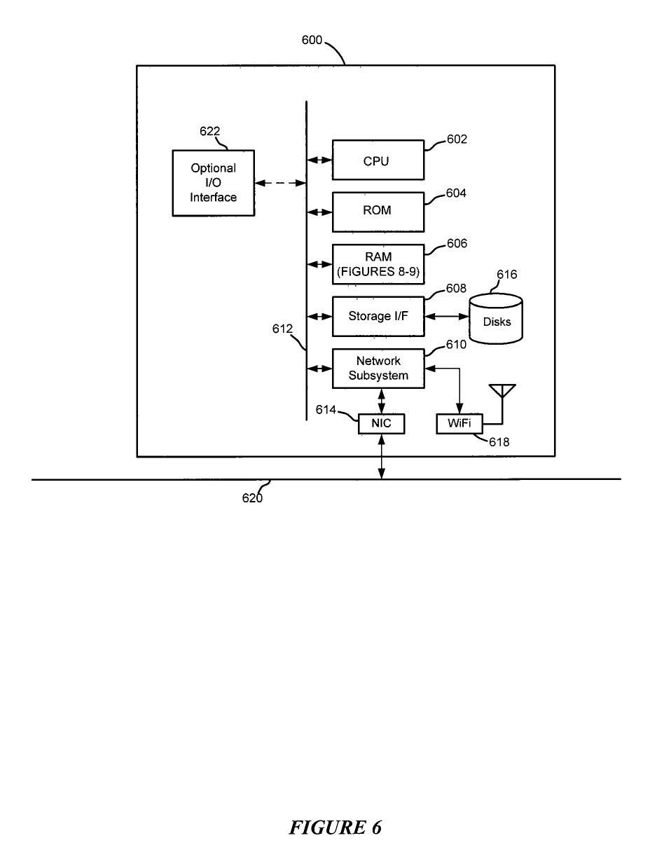

FIG. 1 also depicts a database server 134 and associated data storage device 136 communicatively coupled to the computer network 102 via a suitable communications link 138. It will be appreciated by those skilled in the art that the database server 134 comprises hardware, software, and combinations thereof suitably adapted to provide one or more database services or the like, to networked devices. In accordance with one embodiment of the subject application, the database server 134 includes various components, implemented as hardware, software, or a combination thereof, for managing the retention of document processing device status data, searching for database data, retrieval of database data, and the like, which are accessed via the computer network 102. The communications link 138 is any suitable data communications means known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. It will be appreciated by those skilled in the art that the components for providing database services described with respect to the database server 134 hereinafter are capable of implementation on any computing device coupled to the computer network 102 and functioning as a database system. Functioning of the database server 134 will be better understood in conjunction with the block diagram illustrated in FIG. 6, explained in greater detail below.

Communicatively coupled to the database server 134 is the data storage device 136. In accordance with the preferred embodiment of the subject application, the data storage device 136 is any mass storage device known in the art including, for example and without limitation, magnetic storage drives, a hard disk drive, optical storage devices, flash memory devices, or any suitable combination thereof. In the preferred embodiment, the data storage device 136 is suitably adapted to store electronic database data, user identification data, historical usage data, resource utilization data, and the like. It will be appreciated by those skilled in the art that while illustrated in FIG. 1 as being a separate component of the system 100, the data storage device 136 is capable of being implemented as internal storage component of the database server 134, or the like, such as, for example and without limitation, an internal hard disk drive, or the like.

The system 100 illustrated in FIG. 1 further depicts a management workstation 140, in data communication with the computer network 102 via a communications link 142. It will be appreciated by those skilled in the art that the management workstation 140 is shown in FIG. 1 as a workstation computer for illustration purposes only. As will be understood by those skilled in the art, the management workstation 140 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 142 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the management workstation 140 is suitably adapted to facilitate the retrieval and storage of device status data via the database server 134, receive analysis data in a suitable machine reasoning data format, facilitate communications with a network administrator, generate and transmit user interface modifications, upgrades, updates, personalization data, monitoring commands, or the like, to the document processing devices 104, 114, 124, or any other similar device coupled to the computer network 102.

The system 100 illustrated in FIG. 1 also includes an analysis workstation 144, in data communication with the computer network 102 via a communications link 146. It will be appreciated by those skilled in the art that the analysis workstation 144 is shown in FIG. 1 as a workstation computer for illustration purposes only. As will be understood by those skilled in the art, the analysis workstation 144 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 146 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the analysis workstation 144 is suitably adapted to facilitate the retrieval of device status data from the database on the data storage device 136 associated with the database server 134, perform analysis of retrieved status data, generate machine reasoning format data corresponding thereto, and the like.

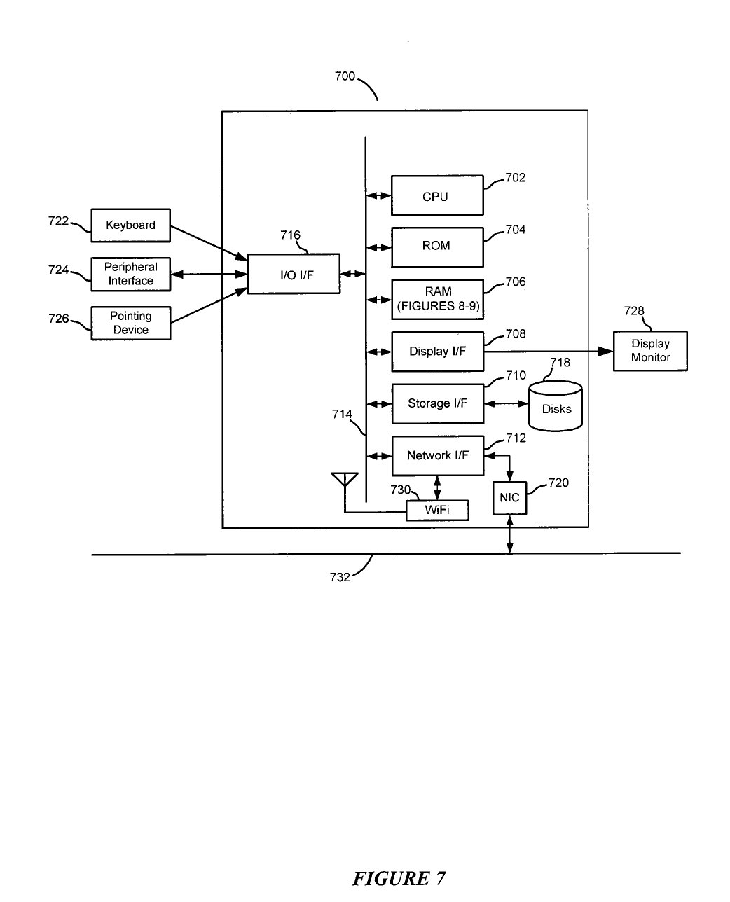

It will be understood by those skilled in the art that the management workstation 140 and the analysis workstation 144 are illustrated in FIG. 1 as separate devices for example purposes only. Thus, the skilled artisan will appreciate that the functions of the management workstation 140 and the analysis workstation 144 are capable of being performed by a single workstation device. Functioning of the management workstation 140 and the analysis workstation 144 will be better understood in conjunction with the block diagram illustrated in FIG. 7, explained in greater detail below.

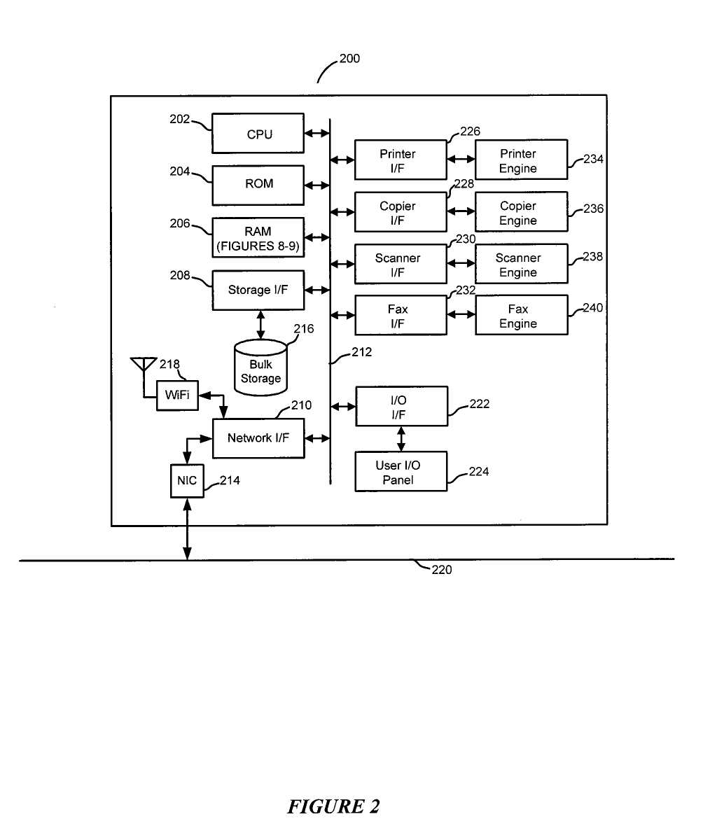

Turning now to FIG. 2, illustrated is a representative architecture of a suitable device 200, (shown in FIG. 1 as the document processing devices 104, 114, and 124), on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

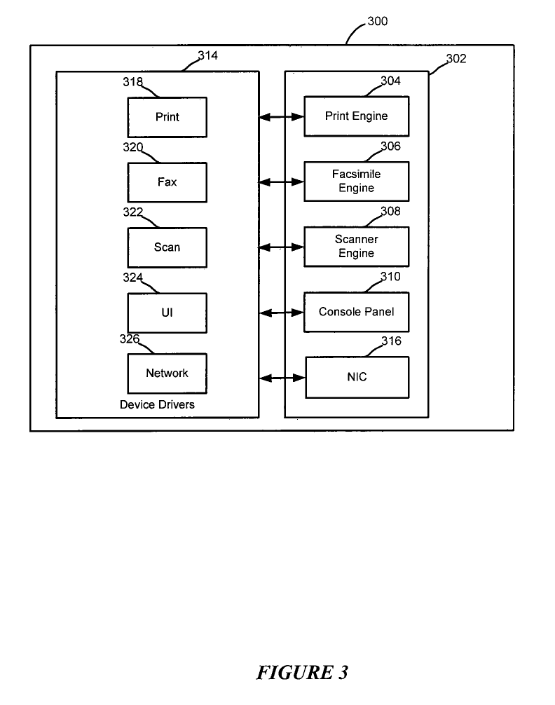

Turning now to FIG. 3, illustrated is a suitable document processing device, (shown in FIG. 1 as the document processing devices 104, 114, and 124), for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers 314 allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, (shown in FIG. 1 as the controllers 108, 118, and 128), on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that the processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by the processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, 114, and 124, which include the controller 400 of FIG. 4, (shown in FIG. 1 as the controllers 108, 118, and 128) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image processor, page description language interpreter or any suitable mechanism for interchange of an electronic document to a format better suited for interchange with device functions such as print 504, facsimile 506 or scan 508.

Finally, the job queue 512 is in data communication with a job parser 518, which job parser suitably functions to receive print job language files from an external device, such as client device services 522. The client device services 522 suitably include printing, facsimile transmission, or other suitable input of an electronic document for which handling by the controller function 500 is advantageous. The job parser 518 functions to interpret a received electronic document file and relay it to the job queue 512 for handling in connection with the afore-described functionality and components.

Turning now to FIG. 6, illustrated is a representative architecture of a suitable server 600, (shown in FIG. 1 as the database server 134), on which operations of the subject system are completed. Included is a processor 602, suitably comprised of a central processor unit. However, it will be appreciated that processor 602 may advantageously be composed of multiple processors working in concert with one another as will be appreciated by one of ordinary skill in the art. Also included is a non-volatile or read only memory 604 which is advantageously used for static or fixed data or instructions, such as BIOS functions, system functions, system configuration, and other routines or data used for operation of the server 600.

Also included in the server 600 is random access memory 606, suitably formed of dynamic random access memory, static random access memory, or any other suitable, addressable memory system. Random access memory provides a storage area for data instructions associated with applications and data handling accomplished by the processor 602.

A storage interface 608 suitably provides a mechanism for volatile, bulk or long term storage of data associated with the server 600. The storage interface 608 suitably uses bulk storage, such as any suitable addressable or serial storage, such as a disk, optical, tape drive and the like as shown as 616, as well as any suitable storage medium as will be appreciated by one of ordinary skill in the art.

A network interface subsystem 610 suitably routes input and output from an associated network allowing the server 600 to communicate to other devices. The network interface subsystem 610 suitably interfaces with one or more connections with external devices to the server 600. By way of example, illustrated is at least one network interface card 614 for data communication with fixed or wired networks, such as Ethernet, token ring, and the like, and a wireless interface 618, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 614 is interconnected for data interchange via a physical network 620, suitably comprised of a local area network, wide area network, or a combination thereof.

Data communication between the processor 602, read only memory 604, random access memory 606, storage interface 608 and the network subsystem 610 is suitably accomplished via a bus data transfer mechanism, such as illustrated by bus 612.

Suitable executable instructions on the server 600 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 622 as will be appreciated by one of ordinary skill in the art.

Turning now to FIG. 7, illustrated is a hardware diagram of a suitable workstation 700, (shown in FIG. 1 as the management workstation 140 and the analysis workstation 144), for use in connection with the subject system. A suitable workstation includes a processor unit 702 which is advantageously placed in data communication with read only memory 704, suitably non-volatile read only memory, volatile read only memory or a combination thereof, random access memory 706, display interface 708, storage interface 710, and network interface 712. In a preferred embodiment, interface to the foregoing modules is suitably accomplished via a bus 714.

The read only memory 704 suitably includes firmware, such as static data or fixed instructions, such as BIOS, system functions, configuration data, and other routines used for operation of the workstation 700 via CPU 702.

The random access memory 706 provides a storage area for data and instructions associated with applications and data handling accomplished by the processor 702.

The display interface 708 receives data or instructions from other components on the bus 714, which data is specific to generating a display to facilitate a user interface. The display interface 708 suitably provides output to a display terminal 728, suitably a video display device such as a monitor, LCD, plasma, or any other suitable visual output device as will be appreciated by one of ordinary skill in the art.

The storage interface 710 suitably provides a mechanism for non-volatile, bulk or long term storage of data or instructions in the workstation 700. The storage interface 710 suitably uses a storage mechanism, such as storage 718, suitably comprised of a disk, tape, CD, DVD, or other relatively higher capacity addressable or serial storage medium.

The network interface 712 suitably communicates to at least one other network interface, shown as network interface 720, such as a network interface card, and wireless network interface 730, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 720 is interconnected for data interchange via a physical network 732, suitably comprised of a local area network, wide area network, or a combination thereof.

An input/output interface 716 in data communication with the bus 714 is suitably connected with an input device 722, such as a keyboard or the like. The input/output interface 716 also suitably provides data output to a peripheral interface 724, such as a USB, universal serial bus output, SCSI, Firewire (IEEE 1394) output, or any other interface as may be appropriate for a selected application. Finally, the input/output interface 716 is suitably in data communication with a pointing device interface 726 for connection with devices, such as a mouse, light pen, touch screen, or the like.

In operation, user identification data is received at each of a plurality of document processing devices corresponding to an identity of a plurality of users. Device status data is then received corresponding to a plurality of document processing operations at each of the document processing devices, wherein a portion of the device status data is associated with user identification data. Structured machine data is then output from each of the document processing devices to an associated data network inclusive of received user identification data and received device data in machine reasoning data format. Structured machine data is then received from each of the document processing devices via the associated network. A database is then generated in accordance with the received machine data. Query data is then received corresponding to a query relative to operation of the document processing devices. Response data is then extracted from the database according to the received query data and a report is generated in accordance with the extracted response data.

In accordance with one example embodiment of the subject application, a management workstation 140 first generates a status data collection instruction in a machine reasoning data format. Preferably, a user associated with the management workstation 140 directs the type of status data to be collected from each of the plurality of document processing devices 104, 114, and 124, as depicted in FIG. 1. The status data collection instruction is then communicated via the computer network 102 to each of the document processing devices 104, 114, and 124 for which status data is desired. According to such an example embodiment, the communications between devices coupled to the computer network 102 illustrated in FIG. 1 include any standard network protocols known in the art. Suitable protocols include, for example and without limitation, Ethernet, TCP/UDP over IPV4 or IPV6, IPX/SPX, WS-Management, WSDM, WBEM, SNMP, or the like. In accordance with one embodiment of the subject application, all processes, and devices use W3C OWL for data representation and manipulation, as will be understood by those skilled in the art.

Each document processing device 104, 114, and 124 receives user identification data corresponding to a plurality of users of the document processing devices 104, 114, and 124. The skilled artisan will appreciate that such user identification data is capable of being received by the document processing devices 104, 114, and 124 via portable storage media, communication from the management workstation 140, retrieved from the server 134, or the like. Preferably, the user identification data is capable of distinguishing each user of the document processing devices 104, 114, and 124 and is associated with the user selection of document processing operations performed by the document processing devices 104, 114, and 124.

The data collection instruction that is received by each document processing device 104, 114, and 124 is then tested by the controller 108, 118, and 128 associated with the recipient devices 104, 114, and 124 to determine whether the instruction is valid. That is, the controller 108, 118, and 128 analyzes the received instruction data to determine whether or not the document processing device 104, 114, or 124 is capable of implementation thereof. When the controller 108, 118, or 128 associated with a recipient document processing device 104, 114, or 124 determines that collection of the data identified in the instruction is not possible, the data includes incompatible syntax, is corrupted, or the like, the management device 140 is notified of the failure to install the instruction, e.g. the user associated with the management device 104 is made aware of the failure to implement the instruction via the computer network 102.

When the controller 108, 118, or 128 or other suitable component associated with the document processing device 104, 114, or 124, respectively, determines that the received data collection instruction is valid, device status data is collected in association with the received user identification data. That is, the controllers 108, 118, and 128 begin data collection of usage information corresponding to users identified by the identification data, including, for example and without limitation, the type of operation selected, the frequency of use by the user, the size of documents processed, and the like. The skilled artisan will appreciate that other suitable status data relating to at least one document processing operation performed on the document processing devices 104, 114, and 124 is also capable of being collected in accordance with the received collection instruction.

The collection of status data in accordance with the received collection instruction continues in such a manner, i.e. the controllers 108, 118, and 128 continue data collection, for example storing such status data in the associated data storage devices 110, 120, and 130, until it is determined that the collected status data is to be forwarded to the database server 134. It will be appreciated by those skilled in the art that the determination of when to send the collected status data to the database server 134 is capable of being based upon the collection instruction associated with each of the document processing devices 104, 114, and 124. Upon such a determination, the controller 108, 118, 128 or other suitable component associated with the document processing device 104, 114, 124 then generates collected data in a machine reasoning format. The collected data in machine reasoning format is then communicated, via the computer network 102, to the database server 134. In accordance with one embodiment of the subject application, the collected data includes data associated with each user, such that the collected data in machine reasoning format includes correlation data between the collected device status data and the user associated therewith.

The database server 134 receives the collected data in machine reasoning format and determines whether or not a database exists corresponding to the received data. In the event that a suitable database does not exist on the database server 134, a database of device status data is generated via the database server 134 on the data storage device 136 in association with the user identification data. Thereafter, the received device status data, is added to the generated database by the database server 134. In the event that a suitable database already exists on the database server 134, the existing database is updated with the received device status data in association with the user identification data. The skilled artisan will appreciate that the device status data, e.g. usage data, resource utilization data, and the like, is collected and stored in association with each user identified by the identification data. Thus, the type of operations performed by a given user, the resources used, the frequency of use, and the like, are capable of being organized by device, by user, by a correlation of the two, or the like. Once the received device status data has been added or updated, the device status data is indexed so as to render such data easily accessible by the database server 134, as will be appreciated by those skilled in the art.

A determination is then made whether or not automatic extraction of device status data is warranted. That is, a determination is made by the database server 134 whether or not the recently added device status data requires the immediate extraction and communication to the analysis workstation 144 for analysis thereof. The skilled artisan will appreciate that certain types of device status data, e.g. errors, hardware failures, excess usage, and the like, are capable of having predetermined notification requirements, i.e. notification to a system administrator. It will also be appreciated by those skilled in the art that the management workstation 140 and the analysis workstation 144 are capable of corresponding to a single workstation device and are illustrated in FIG. 1 as separate devices for example purposes only. When such device status data indicates that immediate notification is required, the database server 134 automatically extracts the device status data and generates corresponding response data. Preferably, the response data is generated in machine reasoning format, suitably capable of being interpreted and processed by the associated analysis workstation 144. Thereafter, the response data is communicated via the computer network 102 from the database server 134 to the analysis workstation 144.

When automatic extraction and notification is not warranted, a determination is made whether query data has been received from an analysis device, e.g. the analysis workstation 144. That is, whether a request for data has been received from the analysis workstation 144 by the database server 134. In accordance with one embodiment of the subject application, suitable query language, e.g. query format is implemented as, for example and without limitation, a W3C OWL Recommendation, such as SPARQL, or the like. In the event that no query has been received, the server 134 returns to receiving device status data from reporting document processing devices 104, 114, 124, managing the databases on the data storage device 136, and the like.

Upon the receipt of a query from the analysis workstation 144, the database server 134 first analyzes the query to determine the data requested. The skilled artisan will appreciate that such request is capable of including a request for device status data specific to a selected user, a selected document processing device 104, 114, 124, a selected type of document processing operation, or the like. The database server 134 then extracts, from the appropriate database, device status data in response to the received query. A query response, preferably in a suitable machine reasoning format, is then generated by the database server 134. The generated response to the query is then communicated to the requesting analysis workstation 144 via the computer network 102. A report is then generated by the analysis workstation 144 upon receipt of the response data corresponding to the query.

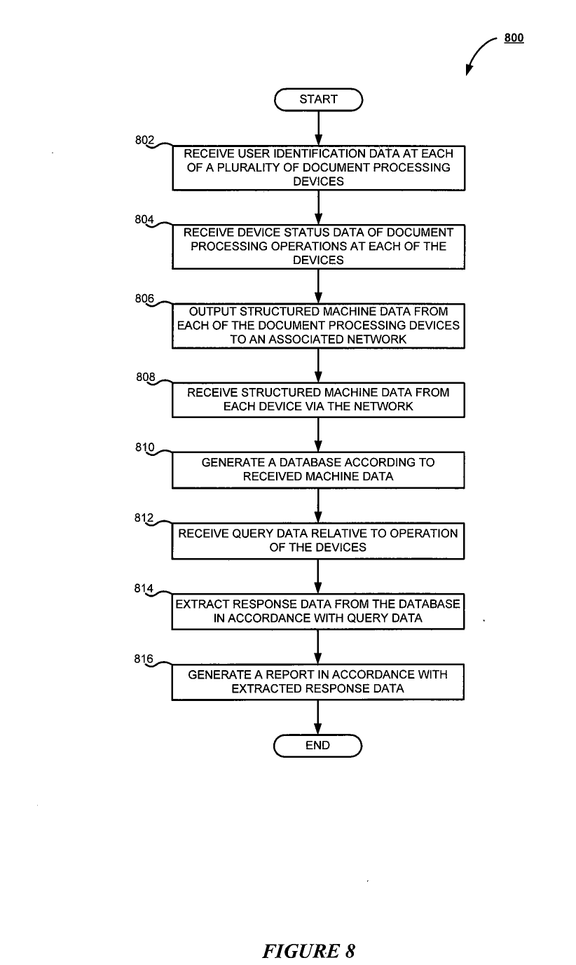

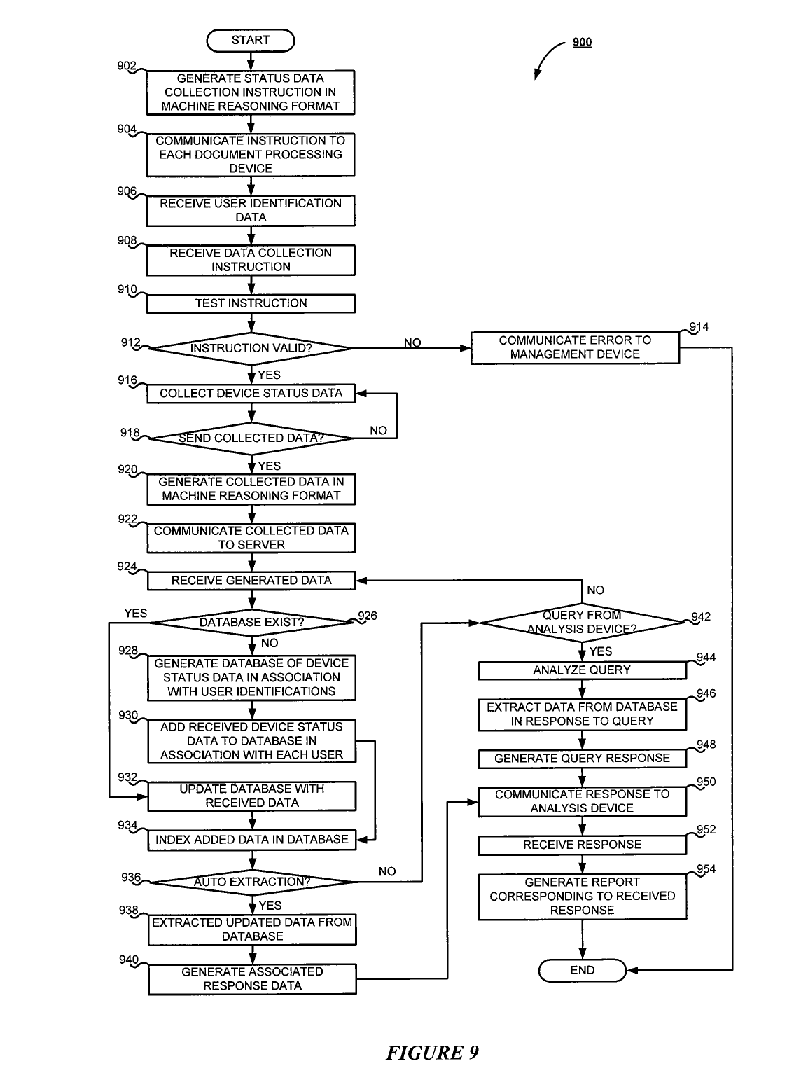

The skilled artisan will appreciate that the subject system 100 and components described above with respect to FIG. 1, FIG. 2, FIG. 3, FIG. 4, FIG. 5, FIG. 6, and FIG. 7 will be better understood in conjunction with the methodologies described hereinafter with respect to FIG. 8 and FIG. 9. Turning now to FIG. 8, there is shown a flowchart 800 illustrating a method for web-based data mining of document processing device information in accordance with one embodiment of the subject application. Beginning at step 802, each of a plurality of document processing devices 104, 114, and 124 receive user identification data corresponding to a plurality of users. It will be understood by those skilled in the art that while three document processing devices 104, 114, and 124 are depicted in FIG. 1, any number of document processing devices in a fleet thereof is capable of being used in accordance with the subject application.

At step 804, device status data corresponding to a plurality of document processing operations at each of the document processing devices 104, 114, and 124 is received, with a portion of the device status data associated with the user identification data. At step 806, each of the document processing devices 104, 114, and 124 outputs structured machine data to the associated data network, e.g. computer network 102, including the received user identification data and the received device data in machine reasoning data format. The structured machine data is then received from each of the document processing devices 104, 114, and 124 via the associated network 102 at step 808. A database is then generated at step 810 in accordance with the received machine data. At step 812, query data is received corresponding to a query relative to operation of the document processing devices 104, 114, and 124. In accordance with the received query data, response data is extracted from the database at step 814. At step 816, a report is generated in accordance with the extracted response data.

Referring now to FIG. 9, there is shown a flowchart 900 illustrating a method for web-based data mining of document processing device information in accordance with one embodiment of the subject application. The methodology of the flowchart 900 depicted in FIG. 9 begins at step 902, whereupon a device status collection instruction is generated in a machine reasoning format by a management workstation 140. In accordance with one example embodiment of the subject application, the type of device status data to be collected, e.g. document processing operation type, document processing operation frequency, resource usage, consumable levels, and the like, is selected by a user associated with the management workstation 140, such as a network administrator, supervisor, or the like. It will be understood by those skilled in the art that the management workstation 140 and the analysis workstation 144 are illustrated in FIG. 1 and discussed hereinafter in FIG. 9 as separate devices for example purposes only. Thus, the skilled artisan will appreciate that the functions of the management workstation 140 and the analysis workstation 144 are capable of being performed by a single workstation device.

At step 904, the generated status data collection instruction is communicated to each of the document processing devices 104, 114, and 124 via the computer network 102. It will be understood by those skilled in the art that each document processing device 104, 114, and 124 on the computer network 102 for which device status data is to be collected receives the status data collection instruction. It will be appreciated by those skilled in the art that any standard network protocols, as are known in the art, are capable of being implemented for communication between the devices of the computer network 102. Suitable protocols include, for example and without limitation, Ethernet, TCP/UDP over IPV4 or IPV6, IPX/SPX, WS-Management, WSDM, WBEM, SNMP, or the like. In accordance with one embodiment of the subject application, all processes, and devices use W3C OWL for data representation and manipulation, as will be understood by those skilled in the art.

At step 906, user identification data is received by each document processing device 104, 114, and 124 corresponding to users of the document processing devices 104, 114, and 124. It will be appreciated by those skilled in the art that the user identification data is capable of being communicated to the document processing devices 104, 114, and 124 via electronic communications from the management workstation 140, via portable storage media, via the server 134, and the like. In accordance with one embodiment of the subject application, the user identification data distinguishes each user of the document processing devices 104, 114, and 124, and is capable of association with document processing operations performed by a given document processing device 104, 114, or 124.

The device status collection instruction is then received by the controllers 108, 118, and 128 or other suitable component of each document processing device 104, 114, and 124 at step 908. At step 910, the received device status collection instruction is tested by the controller 108, 118, 128 or other suitable component associated with the document processing device 104, 114, 124 so as to determine, at step 912, whether the instruction is a valid instruction. Upon a determination at step 912 that the instruction is not valid flow proceeds to step 914, whereupon the invalidity is communicated to the management workstation 140. For example, when the instruction is not comprehensible by the recipient device 104, 114, 124, the instruction includes errors, includes device status requests that are not compatible with the recipient device 104, 114, 124 (such as non-supported document processing operations), the management workstation 140 is notified at step 914 of the inability of the implementation of the device status data collection instruction.

Upon a determination at step 912 that the received device status data collection instruction is valid, flow proceeds to step 916. At step 916, the controller 108, 118, or 128 or other suitable component associated with the document processing device 104, 114, or 124, respectively, begins to collect device status data in association with user identification data according to the received instruction. According to one embodiment of the subject application, device status data is collected corresponding to users identified by the identification data, including, for example and without limitation, the type of operation selected, the frequency of use by the user, consumables used, processing time, resources utilized, and the like. It will be appreciated by those skilled in the art that other suitable device status data relating to at least one document processing operation performed on the document processing devices 104, 114, 124 is also capable of being collected in accordance with the received device status data collection instruction.

A determination is then made at step 918 whether to send the collected status data to the database server 134. Upon a negative determination at step 918, flow returns to step 916, whereupon device status data continues to be collected in accordance with the received device status collection instruction. When it is determined at step 918 that the collected data is ready to be sent, flow proceeds to step 920. That is, the controllers 108, 118, and 128 continue data collection, for example storing such status data in the associated data storage devices 110, 120, and 130, until it is determined that the collected status data is to be forwarded to the database server 134. It will be appreciated by those skilled in the art that the determination to send the collected status data to the database server 134 is made in accordance with the collection instruction associated with each of the document processing devices 104, 114, and 124, previously set per device 104, 114, 124, by an administrative user, or the like. At step 920, the controller 108, 118, 128 or other suitable component associated with the document processing device 104, 114, 124 generates the collected device status data in a machine reasoning format. The collected data in machine reasoning format is then communicated to the database server 134 via the computer network 102 at step 922.

At step 924, the database server 134 receives the device status data in machine reasoning format. A determination is then made at step 926 whether a database exists corresponding to the received device status data. That is, whether a database associated with a given document processing device 104, 114, 124, a selected document processing operation, a selected user, or the like, is stored in the data storage device 136 of the database server 134. Upon a determination at step 926 that a suitable database does not exist on the database server 134, flow proceeds to step 928. At step 928, the database server 134 generates a database of device status data is generated on the data storage device 136 in association with the user identification data. At step 930, the database server 134 adds the received device status data to the newly generated database. Flow then proceeds to step 934 for indexing of the device status data added to the database, as will be discussed in greater detail below.

Returning to step 926, when a determination is made that a database associated with the device status data does exist, flow proceeds to step 932. At step 932, the existing database is updated by the database server 134 to include the received device status data. At step 934, the database server 134 indexes the added data, as will be appreciated by those skilled in the art. In accordance with one embodiment of the subject application, the indexing of the added device status data includes, for example and without limitation, associating the received device status data with a given document processing device 104, 114, 124, a given user (user identification data), a selected type of document processing operation, and any of a myriad of other suitable search and reference terms, as will be understood by those skilled in the art.

Following indexing of the added device status data, flow proceeds from step 934 to step 936. At step 936, a determination is made whether automatic extraction of device status data and associated user identification data is to be made from the database. That is, a determination is made by the database server 134 whether or not the recently added device status data requires the immediate extraction and communication to the analysis workstation 144 for analysis thereof. The skilled artisan will appreciate that certain types of device status data, e.g. errors, hardware failures, excess usage, and the like, are capable of having predetermined notification requirements, i.e. notification to a system administrator. Upon a determination at step 936 that automatic extraction is warranted, flow proceeds to step 938, whereupon the database server 134 automatically extracts the associated device status data, inclusive of any associated user identification data. Response data is then generated by the database server 134 at step 940. Preferably, the response data is generated in machine reasoning format, suitably capable of being interpreted and processed by the associated analysis workstation 144. Thereafter, the response data is communicated via the computer network 102 from the database server 134 to the analysis workstation 144 at step 950.

Upon a determination at step 936 that the automatic extraction of device status data is not required, flow proceeds to step 942, whereupon a determination is made whether query data has been received from the analysis workstation 144. That is, whether a request for data has been received from the analysis workstation 144 by the database server 134. When no query data has been received by the database server 134, flow returns to step 924, and operations with respect to the database server 134 continue as set forth above. When it is determined at step 942 that a query has been received from the analysis workstation 144, flow proceeds to step 944. At step 944, the database server 134 analyzes the query so as to determine the device status data being requested by the analysis device 144. It will be appreciated by those skilled in the art that such a query request is capable of including a request for device status data specific to a selected user, a selected document processing device 104, 114, 124, a selected type of document processing operation, or the like. In accordance with one embodiment of the subject application, suitable query language, e.g. query format is implemented as, for example and without limitation, a W3C OWL Recommendation, such as SPARQL, or the like.

At step 946, the database server 134 extracts device status data corresponding to the received query request from the appropriate database. The database server 134 then generates, at step 948, a query response, preferably in a suitable machine reasoning format. The generated response to the query is then communicated to the requesting analysis workstation 144 via the computer network 102 at step 950. The analysis workstation 144 then receives, at step 952, the response data inclusive of device status data and user identification data corresponding to the query request submitted to the database server 134. Those skilled in the art will appreciate that the management workstation 140 and the analysis workstation 144 are capable of being implemented within a single device and are illustrated in FIG. 1 as separate devices for example purposes only. Thus, the skilled artisan will appreciate that the functions of the management workstation 140 and the analysis workstation 144 are capable of being performed by a single workstation device. At step 954, the analysis workstation 144 generates a report corresponding to the received response data.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for web-based data mining of document processing device information comprising:
a plurality of document processing devices, each document processing device including,
means adapted for receiving user identification data corresponding to an identity of a plurality of users,
means adapted for receiving device status data corresponding to a plurality of document processing operations, wherein at least a portion of the device status data is associated with user identification data, and
means adapted for outputting, to an associated data network, structured machine data inclusive of received user identification data and received device data in machine reasoning data format;
means adapted for receiving structured machine data from each of the plurality of document processing devices via the associated network;
database generation means adapted for generating a database in accordance with received machine data;
means adapted for receiving query data corresponding to a query relative to operation of the plurality of document processing devices;
extraction means adapted for extracting response data from the database in accordance with received query data; and
means adapted for generating a report in accordance with extracted response data.

2. The system of claim 1 wherein the structured machine data is comprised of data structured in web ontology language format.

3. The system of claim 2 wherein the extraction means is comprised of a machine reasoning system.

4. The system of claim 3 wherein the database generation means generates the database inclusive of at least one of a resource definition framework, resource definition framework schema, and OWL web ontology language.

5. The system of claim 1 further comprising an indexing means adapted for generating indexing data in accordance with content of the database.

6. The system of claim 1 wherein the extraction means includes means adapted for automatically extracting response data from the database upon updating thereof with newly received machine data.

7. A method for web-based data mining of document processing device information from a plurality of document processing devices, comprising the steps of:
receiving user identification data corresponding to an identity of a plurality of users at each of a plurality of document processing devices;
receiving device status data corresponding to a plurality of document processing operations at each of the plurality of document processing devices, wherein at least a portion of the device status data is associated with user identification data;
outputting from each of the plurality of document processing devices, to an associated data network, structured machine data inclusive of received user identification data and received device data in machine reasoning data format;
receiving structured machine data from each of the plurality of document processing devices via the associated network;
generating a database in accordance with received machine data;
receiving query data corresponding to a query relative to operation of the plurality of document processing devices;
extracting response data from the database in accordance with received query data; and
generating a report in accordance with extracted response data.

8. The method of claim 7 wherein the structured machine data is comprised of data structured in web ontology language format.

9. The method of claim 8 wherein the step of extracting is via a machine reasoning system.

10. The method of claim 9 wherein the generated database includes at least one of a resource definition framework, resource definition framework schema, and OWL web ontology language.

11. The method of claim 7 further comprising the step of generating indexing data in accordance with content of the database.

12. The method of claim 7 wherein the step of extracting includes automatically extracting response data from the database upon updating thereof with newly received machine data.
